(19) United States
(12) Patent Application Publication
(10) Pub. No.: US 2019/0086571 A1
(43) Pub. Date: Mar. 21, 2019

(54) AN IMPROVED STONELEY WAVE SLOWNESS AND DISPERSION CURVE LOGGING METHOD

(71) Applicant: Halliburton Energy Services, Inc., Houston, TX (US)

(72) Inventor: Kristoffer Thomas Walker, Kingwood, TX (US)

(73) Assignee: Halliburton Energy Services, Inc., Houston, TX (US)

(21) Appl. No.: 15/753,926

(22) PCT Filed: May 11, 2017
(86) PCT No.: PCT/US2017/032254

§ 371 Date: Feb. 20, 2018

Related U.S. Application Data
(60) Provisional application No. 62/341,501, filed on May 25, 2016.

(51) Int. Cl. G01V 1/50; E21B 47/16; G01V 1/46

(52) U.S. Cl. CPC G01V 1/50; E21B 47/16; G01V 2210/6224; G01V 2210/47; G01V 2210/42; G01V 1/46

(57) ABSTRACT

A method to measure borehole Stoneley wave slowness and its associated tool-corrected dispersion curve. The method for measuring borehole Stoneley wave slowness may comprise gathering waveforms, conditioning waveforms, identifying slowness constraints, computing a time-slowness mask, computing a coherence map from differential phase time semblance, processing a two-dimensional time-slowness map, determining slownesses from a one-dimensional variable density log, and tracking time pick from a two-dimensional map. The method may further comprise identifying one or more of coherence, power, instantaneous frequency, signal-to-noise ratio, or error bars from the two-dimensional time-slowness map. The method may further computing a spline interpolation locally around the pick from the one-dimensional variable density log to produce a final data product.

### BACKGROUND

Stoneley waves are seismoacoustic coupled interface waves that are used to analyze reservoir boreholes. These typically high-amplitude waves provide information in various ways about the formation lithologies, stresses, structures both around and intersecting the borehole, and fluids. Stoneley waves may be described as tube waves that propagate between the interface of borehole fluid and wall of the wellbore. The high-amplitude guided waves are generated by a radial (azimuthally symmetric) flexing of the borehole as the acoustic energy is transmitted from the borehole fluid into the rock formation. Since they propagate at low frequencies along the fluid-rock interface at the borehole wall they are sensitive to the rock properties adjacent to the borehole wall. Stoneley waves are very sensitive to fluid mobility, their low-frequency attenuation with propagation along the borehole provides a good indicator of fractures and formation permeability, both of which are of important to formation evaluation and reservoir characterization. They can be measured in both open and cased boreholes, but in cased holes Stoneley-wave features are primarily controlled by the casing rigidity.

### BRIEF DESCRIPTION OF THE DRAWINGS

These drawings illustrate certain aspects of some examples of the present disclosure, and should not be used to limit or define the disclosure.

FIG. 1 illustrate an example of a well measurement system;

FIG. 2 illustrates another example of a well measurement system;

FIG. 3 illustrates workflow for a method of measuring Stoneley wave slowness (DT) and tool-corrected dispersion curve;

FIG. 4 illustrates a first level lookup table dispersion curves for one set of input parameters;

FIG. 5 illustrates a first level picking process;

FIGS. 6a-6d illustrate an example of the method applied to synthetic waveforms from a hard formation;

FIGS. 7a-7d illustrate an example of the method applied to synthetic waveforms from a soft formation;

FIGS. 8a-8f illustrates an example of the Stoneley wave dispersion first level time semblance maps for a real soft formation;

FIG. 9 illustrates measured first level Stoneley slowness logs and associated QC displays for a soft formation;

FIG. 10 illustrates measured first level Stoneley slowness logs and associated QC displays for a soft formation; and

FIG. 11 illustrates measured first level Stoneley slowness logs and associated QC displays for a hard formation.

### DETAILED DESCRIPTION

This disclosure may generally relate to systems and methods for measuring borehole Stoneley wave slowness and its associated tool-corrected dispersion curve. This disclosure may relate to methods of measuring and processing Stoneley waves.

This present disclosure is a new method to measure borehole Stoneley wave slowness and its associated tool-corrected dispersion curve. Traditional methods are prone to a variety of issues including weak Stoneley wave signal-to-noise ratio in large boreholes and soft/permeable formations, interference from leaky P waves or extensional tool mode, and how to calculate the frequency associated with the measured Stoneley wave slowness. This new method works well in large boreholes and soft formations by virtue of using a coherence-based time semblance method with an adaptive picking process that uses constraints provided by wavefield modeling. The possibility of incorrectly picking leaky P waves and extensional tool mode have been eliminated and greatly reduced, respectively.

The dispersion of Stoneley waves provides information about the formation encompassing the borehole. Dispersion is the frequency dependent variation in speed (inverse of “slowness”) as the wave propagations along the borehole axis from one receiver to the next. Dispersion may be measured by comparing the transit time of the waves as they propagate between the receivers. This measurement process may be done in the time domain (time semblance) if the frequencies in the transmitted wave are well separated in time, or in the frequency domain (frequency semblance). Typically the source is not ideal, but time semblance is used nonetheless because it has the advantage of being able to easily separate most types of arrivals in time-slowness space for measurement by careful source-receiver configuration. In the limit of a monochromatic source signal (either via filtering or by source design), the time and frequency semblance results will yield the same slowness measurement regardless of the source type.

In a soft formation, Stoneley waves exhibit normal dispersive behavior, and lower frequencies travel at faster speeds. In a hard formation, reverse dispersion is observed, and lower frequencies travel at slower speeds. Among these first-order variations are smaller variations due to other geophysical influences such as VTI (vertical transverse isotropy) and fluctuations in the permeability, borehole diameter, and mud properties. The Stoneley wave slowness logs are also useful as a QC criterion because Stoneley waves routinely contaminate other types of waves of interest such as flexural waves, and one may overlay the slowness information obtained from pure-Stoneley measurements upon the information obtained from other types of measurements to evaluate if Stoneley contamination may be an issue. In examples, Stoneley measurements may be performed by a well measurement system.

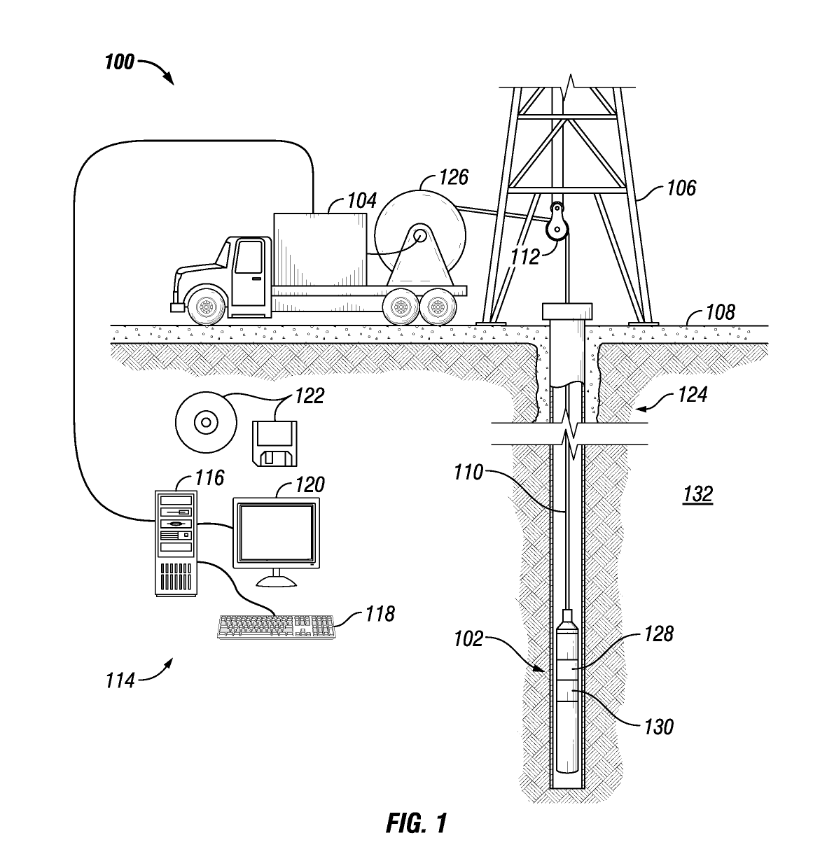

FIG. 1 illustrates a cross-sectional view of a well measurement system 100. As illustrated, well measurement system 100 may comprise downhole tool 102 attached a vehicle 104. In examples, it should be noted that downhole tool 102 may not be attached to a vehicle 104. Downhole tool 102 may be supported by rig 106 at surface 108. Downhole tool 102 may be tethered to vehicle 104 through conveyance 110. Conveyance 110 may be disposed around one or more sheave wheels 112 to vehicle 104. Conveyance 110 may include any suitable means for providing mechanical conveyance for downhole tool 102, including, but not limited to, wireline, slickline, coiled tubing, pipe, drill pipe, downhole tractor, or the like. In some embodiments, conveyance 110 may provide mechanical suspension, as well as electrical connectivity, for downhole tool 102. Conveyance 110 may comprise, in some instances, a plurality of electrical conductors extending from vehicle 104. Conveyance 110 may comprise an inner core of seven electrical conductors covered by an insulating wrap. An inner and outer steel armor sheath may be wrapped in a helix in opposite directions around the conductors. The electrical conductors may be used for communicating power and telemetry between vehicle 104 and downhole tool 102. Information from downhole tool 102 may be gathered and/or processed by information handling system 114. For example, signals recorded by downhole tool 102 may be stored on memory and then processed by downhole tool 102. The processing may be performed real-time during data acquisition or after recovery of downhole tool 102. Processing may alternatively occur downhole or may occur both downhole and at surface. In some embodiments, signals recorded by downhole tool 102 may be conducted to information handling system 114 by way of conveyance 110. Information handling system 114 may process the signals, and the information contained therein may be displayed for an operator to observe and stored for future processing and reference. Information handling system 114 may also contain an apparatus for supplying control signals and power to downhole tool 102.

Systems and methods of the present disclosure may be implemented, at least in part, with information handling system 114. Information handling system 114 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 114 may be a processing unit 116, a network storage device, or any other suitable device and may vary in size, shape, performance, functionality, and price. Information handling system 114 may include random access memory (RAM), one or more processing resources such as a central processing unit (CPU) or hardware or software control logic, ROM, and/or other types of nonvolatile memory. Additional components of the information handling system 114 may include one or more disk drives, one or more network ports for communication with external devices as well as various input and output (I/O) devices, such as a input device 118 (e.g, keyboard, mouse, etc.) and a video display 120. Information handling system 114 may also include one or more buses operable to transmit communications between the various hardware components.

Alternatively, systems and methods of the present disclosure may be implemented, at least in part, with non-transitory computer-readable media 122. Non-transitory computer-readable media 122 may include any instrumentality or aggregation of instrumentalities that may retain data and/or instructions for a period of time. Non-transitory computer-readable media 122 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

In examples, rig 106 includes a load cell (not shown) which may determine the amount of pull on conveyance 110 at the surface of borehole 124. Information handling system 114 may comprise a safety valve which controls the hydraulic pressure that drives drum 126 on vehicle 104 which may reels up and/or release conveyance 110 which may move downhole tool 102 up and/or down borehole 124. The safety valve may be adjusted to a pressure such that drum 126 may only impart a small amount of tension to conveyance 110 over and above the tension necessary to retrieve conveyance 110 and/or downhole tool 102 from borehole 124. The safety valve is typically set a few hundred pounds above the amount of desired safe pull on conveyance 110 such that once that limit is exceeded; further pull on conveyance 110 may be prevented.

Downhole tool 102 may comprise a transmitter 128 and/or a receiver 130. In examples, downhole tool 102 may operate with additional equipment (not illustrated) on surface 108 and/or disposed in a separate well measurement system (not illustrated) to record measurements and/or values from formation 132. During operations, transmitter 128 may broadcast a signal from downhole tool 102. Transmitter 128 may be connected to information handling system 114, which may further control the operation of transmitter 128. Additionally, receiver 130 may measure and/or record signals broadcasted from transmitter 128. Receiver 130 may transfer recorded information to information handling system 114. Information handling system 114 may control the operation of receiver 130. For example, the broadcasted signal from transmitter 128 may be reflected by formation 132. The reflected signal may be recorded by receiver 130. The recorded signal may be transferred to information handling system 114 for further processing. In examples, there may be any suitable number of transmitters 128 and/or receivers 130, which may be controlled by information handling system 114. Information and/or measurements may be processed further by information handling system 114 to determine properties of borehole 124, fluids, and/or formation 132.

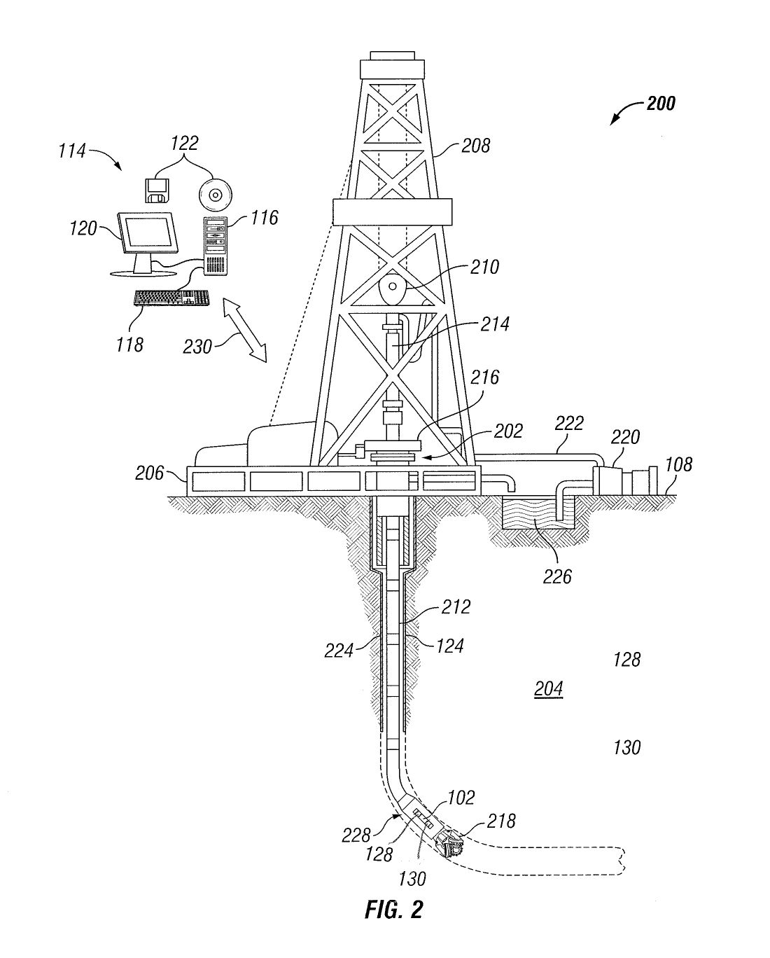

FIG. 2 illustrates an example in which downhole tool 102 (Referring to FIG. 1) may be disposed in a drilling system 200. As illustrated, borehole 124 may extend from a wellhead 202 into a subterranean formation 204 from surface 108 (Referring to FIG. 1). Generally, borehole 124 may include horizontal, vertical, slanted, curved, and other types of wellbore geometries and orientations. Borehole 124 may be cased or uncased. In examples, borehole 124 may comprise a metallic material. By way of example, the metallic member may be a casing, liner, tubing, or other elongated steel tubular disposed in borehole 124.

As illustrated, borehole 124 may extend through subterranean formation 204. As illustrated in FIG. 2, borehole 124 may extending generally vertically into the subterranean formation 204, however borehole 124 may extend at an angle through subterranean formation 204, such as horizontal and slanted wellbores. For example, although FIG. 2 illustrates a vertical or low inclination angle well, high inclination angle or horizontal placement of the well and equipment may be possible. It should further be noted that while FIG. 2 generally depicts a land-based operation, those skilled in the art may recognize that the principles described herein are equally applicable to subsea operations that employ floating or sea-based platforms and rigs, without departing from the scope of the disclosure.

As illustrated, a drilling platform 206 may support a derrick 208 having a traveling block 210 for raising and lowering drill string 212. Drill string 212 may include, but is not limited to, drill pipe and coiled tubing, as generally known to those skilled in the art. A kelly 214 may support drill string 212 as it may be lowered through a rotary table 216. A drill bit 218 may be attached to the distal end of drill string 212 and may be driven either by a downhole motor and/or via rotation of drill string 212 from surface 108. Without limitation, drill bit 218 may include, roller cone bits, PDC bits, natural diamond bits, any hole openers, reamers, coring bits, and the like. As drill bit 218 rotates, it may create and extend borehole 124 that penetrates various subterranean formations 204. A pump 220 may circulate drilling fluid through a feed pipe 222 to kelly 214, downhole through interior of drill string 212, through orifices in drill bit 218, back to surface 108 via annulus 224 surrounding drill string 212, and into a retention pit 226.

With continued reference to FIG. 2, drill string 212 may begin at wellhead 202 and may traverse borehole 124. Drill bit 218 may be attached to a distal end of drill string 212 and may be driven, for example, either by a downhole motor and/or via rotation of drill string 212 from surface 108 (Referring to FIG. 1). Drill bit 218 may be a part of bottom hole assembly 228 at distal end of drill string 212. Bottom hole assembly 228 may further comprise downhole tool 102 (Referring to FIG. 1). Downhole tool 102 may be disposed on the outside and/or within bottom hole assembly 228. Downhole tool 102 may comprise a plurality of transmitters 128 and receivers 130 (Referring to FIG. 1). Downhole tool 102 and/or the plurality of transmitters 128 and receivers 130 may operate and/or function as described above. As will be appreciated by those of ordinary skill in the art, bottom hole assembly 228 may be a measurement-while drilling (MWD) or logging-while-drilling (LWD) system.

Without limitation, bottom hole assembly 228, transmitter 128, and/or receiver 130 may be connected to and/or controlled by information handling system 114 (Referring to FIG. 1), which may be disposed on surface 108. Without limitation, information handling system 114 may be disposed down hole in bottom hole assembly 228. Processing of information recorded may occur down hole and/or on surface 108. Processing occurring downhole may be transmitted to surface 108 to be recorded, observed, and/or further analyzed. Additionally, information recorded on information handling system 114 that may be disposed down hole may be stored until bottom hole assembly 228 may be brought to surface 108. In examples, information handling system 114 may communicate with bottom hole assembly 228 through a communication line (not illustrated) disposed in (or on) drill string 212. In examples, wireless communication may be used to transmit information back and forth between information handling system 114 and bottom hole assembly 228. Information handling system 114 may transmit information to bottom hole assembly 228 and may receive as well as process information recorded by bottom hole assembly 228. In examples, a downhole information handling system (not illustrated) may include, without limitation, a microprocessor or other suitable circuitry, for estimating, receiving and processing signals from bottom hole assembly 228. Downhole information handling system (not illustrated) may further include additional components, such as memory, input/output devices, interfaces, and the like. In examples, while not illustrated, bottom hole assembly 228 may include one or more additional components, such as analog-to-digital converter, filter and amplifier, among others, that may be used to process the measurements of bottom hole assembly 228 before they may be transmitted to surface 108. Alternatively, raw measurements from bottom hole assembly 228 may be transmitted to surface 108.

Any suitable technique may be used for transmitting signals from bottom hole assembly 228 to surface 108, including, but not limited to, wired pipe telemetry, mud-pulse telemetry, acoustic telemetry, and electromagnetic telemetry. While not illustrated, bottom hole assembly 228 may include a telemetry subassembly that may transmit telemetry data to surface 108. Without limitation, an electromagnetic source in the telemetry subassembly may be operable to generate pressure pulses in the drilling fluid that propagate along the fluid stream to surface 108. At surface 108, pressure transducers (not shown) may convert the pressure signal into electrical signals for a digitizer (not illustrated). The digitizer may supply a digital form of the telemetry signals to information handling system 114 via a communication link 230, which may be a wired or wireless link. The telemetry data may be analyzed and processed by information handling system 114.

As illustrated, communication link 230 (which may be wired or wireless, for example) may be provided that may transmit data from bottom hole assembly 228 to an information handling system 114 at surface 108. Information handling system 114 may include a processing unit 116 (Referring to FIG. 1), a video display 120 (Referring to FIG. 1), an input device 118 (e.g., keyboard, mouse, etc.) (Referring to FIG. 1), and/or non-transitory computer-readable media 122 (e.g., optical disks, magnetic disks) (Referring to FIG. 1) that may store code representative of the methods described herein. In addition to, or in place of processing at surface 108, processing may occur downhole.

Bottom hole assembly 228 may comprise a transmitter 128 and/or a receiver 130. In examples, bottom hole assembly 228 may operate with additional equipment (not illustrated) on surface 108 and/or disposed in a separate well measurement system (not illustrated) to record measurements and/or values from subterranean formation 204. During operations, transmitter 128 may broadcast a signal from bottom hole assembly 228. Transmitter 128 may be connected to information handling system 114, which may further control the operation of transmitter 128. Additionally, receiver 130 may measure and/or record signals broadcasted from transmitter 128. Receiver 130 may transfer recorded information to information handling system 114. Information handling system 114 may control the operation of receiver 130. For example, the broadcasted signal from transmitter 128 may be reflected by subterranean formation 204. The reflected signal may be recorded by receiver 130. The recorded signal may be transferred to information handling system 114 for further processing. In examples, there may be any suitable number of transmitters 128 and/or receivers 130, which may be controlled by information handling system 114. Information and/or measurements may be processed further by information handling system 114 to determine properties of borehole 124 (Referring to FIG. 1), fluids, and/or subterranean formation 204.

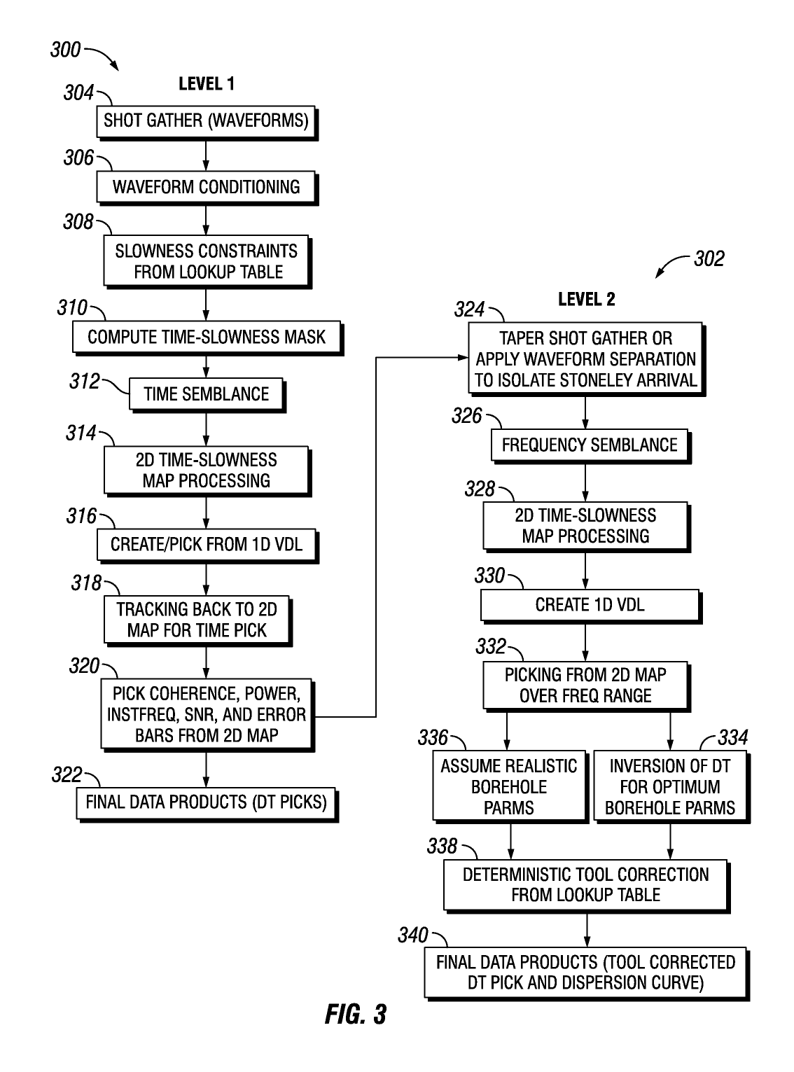

The method being proposed is shown in FIG. 3. The method may comprise two levels. First level 300 yields a Stoneley slowness value (called “DT pick” or “DT peak”) and its associated values such as time, amplitude, frequency, and signal to noise ratio. Second level 302 uses input provided by the first level 300 to compute a more useful tool-corrected, Stoneley dispersion curve. First level 300 may be designed to be impervious to variations in formation 132 (Referring to FIG. 1). The method works robustly for all formation types from hard formations (DTC=45 μs/ft) to very soft formations (DTC=300 μs/ft) without a need to modify input parameters. DTC is defined as the formation compressional slowness in micro-seconds per foot.

FIG. 3 illustrates an iteration of a loop over acquisition of Stoneley firing waveforms at a discrete tool depths. First level 300 may begin by gathering the waveforms into a shot gather 304 through waveform separation. This may comprise broadcasting a waveform from transmitter 128 into formation 132 (Referring to FIG. 1). In examples, an explosion on surface 108 (Referring to FIG. 1) and/or formation 132, may produce a waveform which may traverse through formation 132. Reflection of the waveform off formation 132 may be received by receiver 130 (Referring to FIG. 1). The recorded waveform may comprise multiple waveforms from multiple reflections in formation 132. The waveforms may be separated to form a shot gather 304. Next, waveform conditioning 306 may apply a trend removal or filtering process to improve the signal level with respect to noise. For example, the waveforms may be band-pass filtered with the high cut frequency of the filter depending on the value of the formation compressional slowness. A fast or hard formation may have a cut-off frequency of 2.5 kHz. A slow or soft formation may have a cut-off frequency of 1.5 kHz.

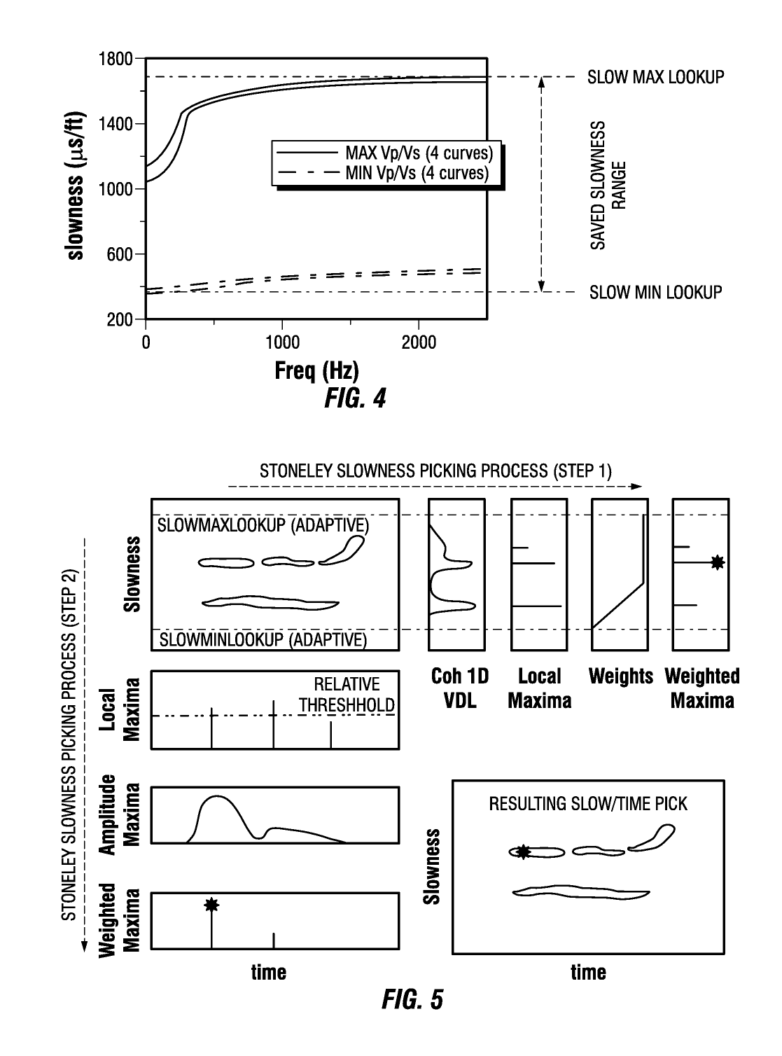

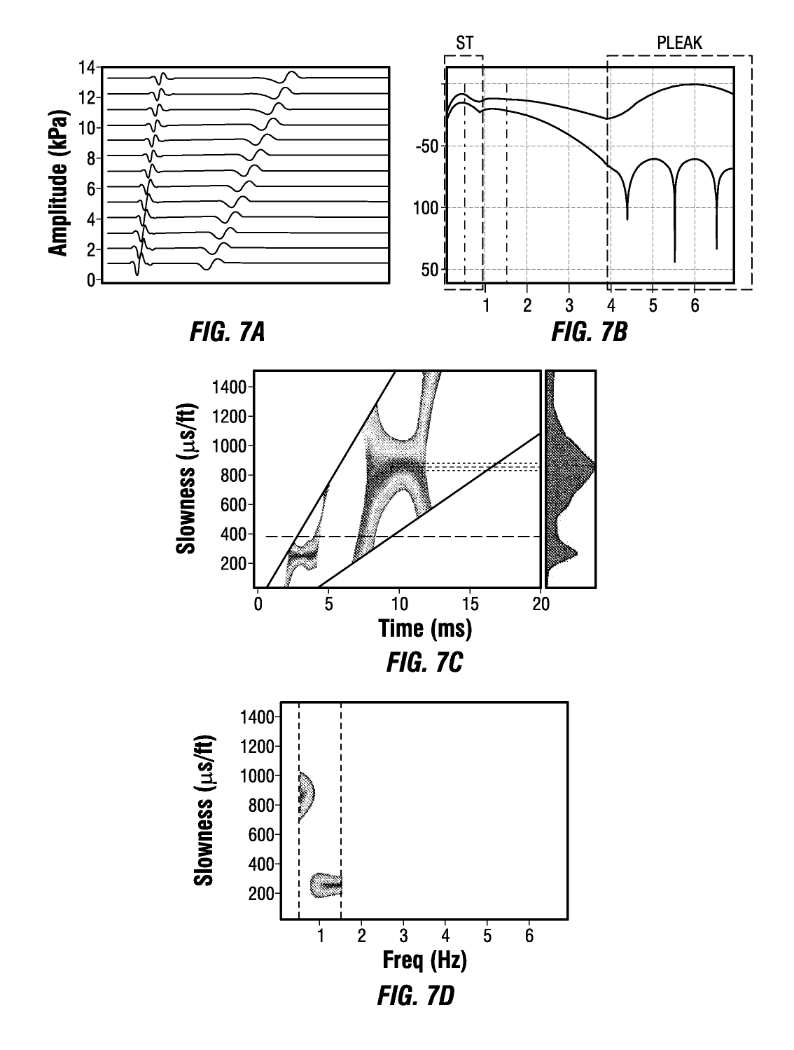

Waveform conditioning 306 may be followed by consulting a lookup table 308 to provide an estimation of the minimum and maximum possible Stoneley slowness that may be picked from within time semblance 312, discussed below. Lookup table 308 may be pre-computed, and may be parameterized for only three inputs: formation compressional slowness (DTC), mud density, and borehole diameter. The computation of lookup table 308 uses several first-order, empirical relationships to reduce the number of unknown dimensions from six to three. For each set of three input parameters, eight different tool-corrected Stoneley wave dispersion curves for an isotropic formation may be computed. In FIG. 4, dispersion curves from lookup table 308 are illustrated for one set of input parameters. In this case the following parameters were used to generate the curves: DTC=235 us/ft, mud density=8 lb/gal, Borehole Diameter=8.3 in. The minimum and maximum value may be used to restrict the search for the Stoneley slowness in the 1D VDL, as illustrated in FIG. 6. The minimum and maximum slowness considering all eight dispersion curves may be saved to lookup table 308, referring to FIG. 3. The large slowness range shown in FIG. 4 may be because a minimum and maximum formation shear slowness may be predicted using empirical geological relationships. In examples, the slowness range may be reduced by using the measured DTS (shear sonic travel time) as an input parameter. These slowness min/max values may be saved for later use.

After consulting lookup table 308, a time-slowness mask 310 may be computed. Time-slowness mask 310 is a polygon in time-slowness space that defines what time-slownesses are physically reasonable for the target Stoneley guided waves of interest. The first step in computing time-slowness mask 310 is to measure the delay to the onset of energy in the transmitter drive pulse as well as the duration of significant energy in the drive pulse. The computation of time-slowness mask 310 may then utilize the transmitted signal's time delay and duration measurements as well as the minimum/maximum slownesses (30 to 1500 s/ft) to compute a window in the time/slowness space. This information may be computed once before processing an entire log if the variations in borehole conditions do not change significantly from one depth to the next. Alternatively, time-slowness mask 310 may be re-computed at each depth, taking information about the borehole diameter, for example, that may be measured by a different tool.

The next step may be to use differential Phase Time Semblance 312 to process a 2-D time-slowness map 314, which may also comprise a semblance (or coherence) map, amplitude (beam) map, signal-to-noise ratio map, instantaneous frequency map, and instantaneous frequency standard deviation map. These may be all “raw” maps that have values for all time sample points. These maps may then be smoothed by an averaging filter and subsequently masked based on the time/slowness mask, as well as threshold parameters input by the user. The instantaneous frequency calculation is the average of instantaneous frequency along the predicted travel-time curves. Similarly, the standard deviation may be defined in the same way. The instantaneous frequency may be only an accurate measurement of dominant frequency at a given time sample if the signal is not a broad-band, impulsive signal. The narrow frequency band used may be sufficient to estimate the dominant frequency of the slowness pick at the pick location in the 2D map.

In the 2-D coherence map, all map values less than the threshold value may be masked to 0. In the 2-D amplitude map, the maximum value may be identified and then all values below a percentage threshold of that global maximum are masked to 0. For the signal-to-noise ratio map, it may be created by computing the median value of the amplitude map, which may be a reliable measure of the noise level. Then a signal-to-noise ratio calculation may be performed on the amplitude map using that noise level, leading to a map where 0 dB represents a potentially unreliable derived answer, and anything above 0 dB may be deemed reliable from a signal-to-noise level perspective. The 2-D coherence calculation may be a sensitive method and sometimes real coherence is significant even when signals have <0 dB SNR (signal-to-noise ratio). This is a well-known property of signal detection in noisy environments. The SNR map may then be masked for all values below the user defined SNR threshold. In summary, the existence of a non-masked pixel in the “final coherence map” indicates it has passed these four different QC methods (reasonable time-slowness consistency, coherence, amplitude, and SNR).

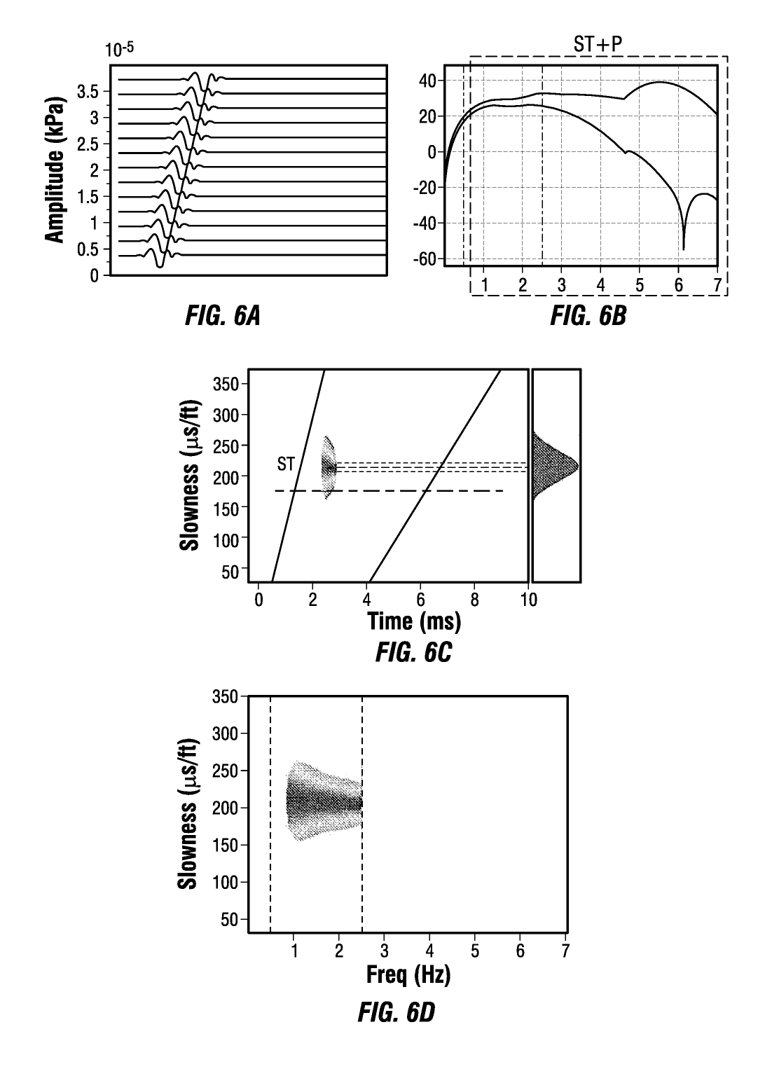

The next step may be the creation of a Variable Density Log (VDL) 316. This is a one-dimensional function that is essentially a projection of the 2-D coherence map along the time axis to create an array of coherence as a function of slowness. The projection may be a weighted average method. This method was designed to take advantage of the redundancy provided along the time axis of coherence signals (FIG. 5). This method applies a multiplier defined by a weighting function to the 2-D maps before summing the values across time to form the 1D VDL. The weighting function may be the same single function of time for all slownesses (1-D). It may be calculated at each time sample by taking the maximum value over all slownesses, then dividing that array by the cumulative summation of those maximum coherences. This has the effect of preserving in the resulting VDL detections in the 2-D map that are elongated in time, at the expense of detections at other slownesses that are short in time duration.

A time pick 318 tracking back to the 2-D map may be the next step. This may comprise picking the slowness value from the 1-D VDL 316 (FIG. 4). A plurality of slowness picks may be made by searching the VDL 316 for local maxima between the two slowness that constrain the possible Stoneley slownesses. These two slowness end members may come from the lookup table. A weighting function may be applied to these candidate picks from 0 at the minimum slowness up to 1 at some threshold distance toward the maximum slowness. The final Stoneley wave slowness pick is made by simply choosing the candidate pick that has the highest weighted coherence. The motivation of this weighting function comes from the need to pick Stoneley amongst leaky P waves and the extensional tool mode when signal-to-noise ratios may be very low, such as in a very soft formation or large borehole. The weighting function may be adaptive because it depends on the current DTC value, borehole diameter, and mud density. Additionally, in this process a spline interpolation performed locally around the pick in the 1-D VDL may be performed and a DTST may be picked again with a higher precision than the coarse slowness step size.

The next step is to pick parameter 320. For example, parameters may comprise coherence, power, InstFreq, SNR, and error bars. For this purpose, the local maxima that exist along the time axis that have coherences greater than a percentage of the maximum coherence are weighted using the amplitude (from the amplitude 2-D map) along that same time axis at the same slowness (FIG. 5). The final time pick may be based on the maximum weighted coherence. Once the time/slowness pick has been made, it is possible to find the associated amplitude, SNR, frequency, and frequency standard deviation directly from the other 2-D maps at that associated pick location. Because multiple detections at other slownesses may be influence the resulting VDL peak coherence value such that this VDL coherence value does not equal the associated coherence values in the 2-D map, the 1-D VDL may be rescaled to have the same coherence value as in the 2-D map for the picked slowness location.

The final data product 322 may comprise a step of estimating slowness uncertainty. This is simply a measurement of the slowness width of the VDL as defined by the distance between the slownesses associated with a threshold proportion of the maximum coherence. This uncertainty may not be a rigorously defined uncertainty, but it may correctly scales with the variations in dominant waveform frequency and receiver array aperture that influence accuracy. Furthermore, it does not change significantly with variations in the 2-D map threshold parameters.

First level 300 in FIG. 3 may be applicable to a real-time logging environment, and subsequent examples of its use may be shown in following sections. In this capacity, the Stoneley slowness may be useful as a QC criterion to determine if other sonic logs such as the compressional DTC and flexural DTS logs are trustworthy and not corrupted by Stoneley wave contamination. There are several limitations of the information provided by first level 300. First, the slowness may only be known at one frequency point. The measurement may also be made in the time domain, which is known to yield slownesses that may not always be in agreement with frequency semblance results, in part due to the influence of the non-ideal drive pulse. The slowness may also not be corrected for the effects of the tool, which tends to move the Stoneley dispersion curve toward lower frequencies. Finally, the entire dispersion curve and a prediction of the 0 Hz slowness may be useful for advanced applications.

The issue with using frequency semblance as the core method in first level 300 is that different arrivals in the waveform (direct wave, P, leaky P, tool modes, or back reflections) interfere with each other in frequency space. This interference causes the correlation values at any specific frequency shared by the different arrivals to be much less than the time semblance equivalent. In order to use frequency semblance productively, the different arrivals may be removed from the analysis. There may be two ways to achieve this. The first may be to taper the input waveforms to remove any energy that may be associated with other arrivals, leaving only the energy associated with the primary Stoneley wave. The second way may be to use a wave separation algorithm, such as an FK filter, radon filter, or simply subtracting directional beams (also called stacks) from the waveforms. Regardless of the method, the slowness(es) and or pick time(s) associated with the primary Stoneley wave may be needed in order to isolate it from the other arrivals.

Second level 302 may be an optional extension of first level 300 using the picked slownesses to separate the primary Stoneley wave from the other arrivals. In examples, the slowness associated with the maximum coherence in the 2-D maps may be mapped from the time-slowness space to the time-offset space. Starting at picking parameter 320, second level 302 may begin by determining Stoneley arrival 324. This may comprise proceeding in both time directions for each receiver waveform of slowness versus time, an edge detection algorithm may be applied to find the edges of the Stoneley wave slownesses. A best-fit straight line may be drawn through these edges, defining two edges of a polygon in time-offset space that spans the energy associated with the Stoneley wave slownesses. This polygon may then be used with a taper to mute all non-primary Stoneley energy. This method may remove both forward and back reflected Stoneley waves providing enough separation distance between them exists.

Next may be to use frequency semblance 326 to compute a coherence map, amplitude map, and signal-to-noise ratio map just like that done for the time semblance approach in first level 300. Although the time-slowness mask does not apply in this case, the other threshold masks may still be applied. The next step may be to convert the 2-D map 328 to a 1-D VDL 330. This may be done using the same weighted averaging method used in first level 300. The slowness picking process may be trivial and defined by the edges of the masked detection in the slowness/frequency space 332. This results in a Stoneley dispersion curve that has the tool influence included. The next step may take two different paths. If computational speed is available, one may use the dispersion curve to perform an inversion 334 (using a lookup table of precomputed dispersion curves) of certain unknown parameters (e.g., mud and formation density). Then using these inverted parameters, one may use another lookup table to determine the frequency-dependent tool correction 338, and apply it to the observed dispersion curve to determine a final data product 340. Final data product 340 may compute a tool correct Stoneley slowness values and a dispersion curve. The other path way may be to assume realistic borehole parameters 336. Known parameters (DTC, DTS, mud density, and borehole diameter) provide sufficient estimations of the unknown parameters (e.g., mud and formation density) such that the difference between the tool correction for the true set of parameters and the estimated set of parameters may be insignificant. In other words, if the true mud speed is 260 μs/ft, but it was estimated to be 230 μs/ft based on a mud density empirical relationship, if the difference in the tool correction for these two scenarios is insignificant, then inverting for those unknown parameters nay not be important and one may simply correct the observed dispersion curve using a pre-computed lookup table. Of course, one could make this lookup table have increasingly higher levels of complexity, such as including the effects of VTI anisotropy.

As a test of the algorithm, first level 300 may be applied to synthetic waveforms generated using a full-wavefield modeling algorithm. Two models were generated for a hard and soft formation. The hard formation example is shown in FIG. 6. The inputs used to generate FIG. 6 are: DTC=50 μs/ft, 15 PPG mud, and 16″ borehole diameter. The horizontal line in time semblance indicates the lower bound of the restricted slowness search space provided by the lookup table. The Stoneley wave has a relatively large amplitude of ˜0.3E-5 kPa, and the compressional wave may be barely visible. The VDL only shows the Stoneley wave because of the 2-D masking that has filtered out other weaker arrivals.

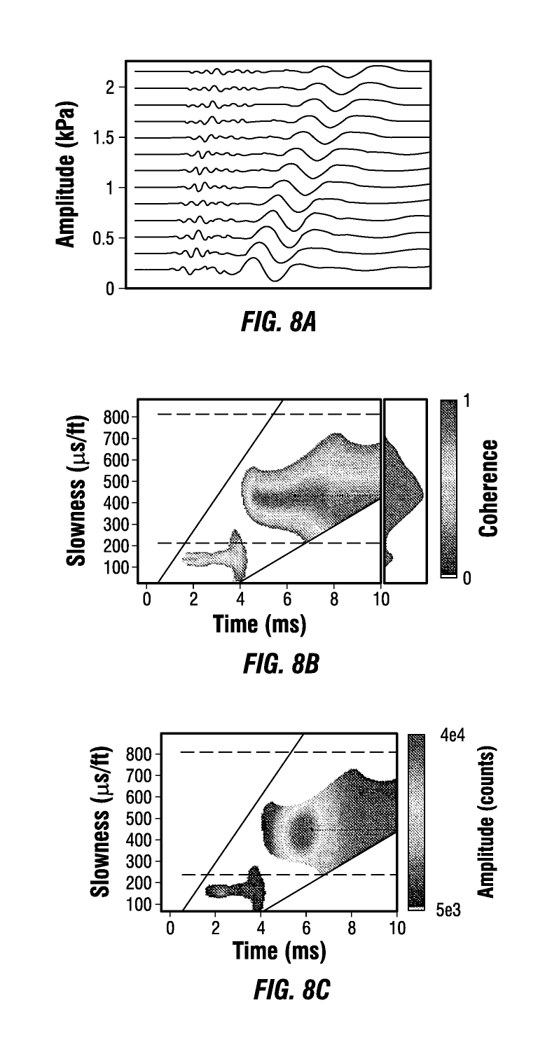

The second simulation is for a soft formation (FIG. 7). The horizontal line in time semblance indicates the lower bound of the restricted slowness search space provided by the lookup table. The Stoneley wave amplitude in the time series in this case is about 1e-8 kPa. This is two orders of magnitude lower than for the hard formation case. The leaky P arrival is clearly visible and the dominant arrival in terms of amplitude in time series.

In both hard and soft examples, the Stoneley wave energy in time semblance is clearly above the minimum Stoneley wave slowness predicted by the lookup table dispersion curve modeling. For this particular hard formation case, this constraint was not necessary to guarantee picking the Stoneley slowness. However, for the soft formation case, the leaky P arrival may be outside of the slowness space scanned in the 1D VDL, and it may not be considered in the slowness picking process (FIG. 5). Even if leaky P extends inside the permitted Stoneley slowness range, the weighting function will attenuate its influence as well as the influence from the extensional tool mode.

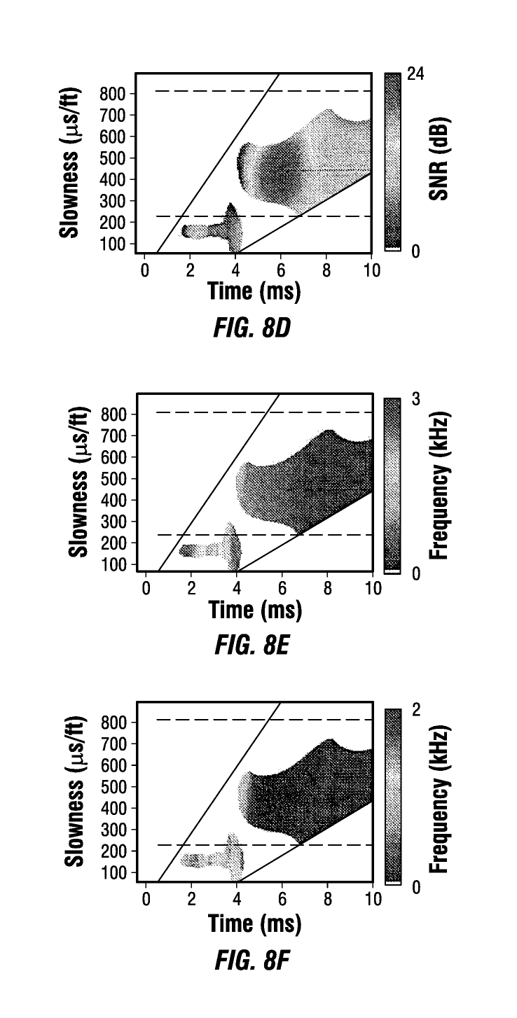

Next, first level 300 was applied to real data from a well. FIG. 8 shows an example from a soft formation. FIG. 8 illustrates the following data: (a) filtered shot gather, (b) coherence map with slowness pick, error bars, and associated 1D variable density log (VDL), (c) average instantaneous amplitude map, (d) signal to noise ratio map, (e) average instantaneous frequency map, and (f) instantaneous frequency standard deviation map. The pick of 425 μs/ft at 6.2 ms is shown as a square in all 4 maps. The horizontal black line indicates the lower bound of the range of slowness that may be scanned for coherence peaks in the 1D VDL. This figure shows the final slowness/time pick and error bars on the different 2D maps. For illustrative purposes, the thresholds have been reduced to permit visualizing more of the maps. The upper right shows the final coherence map and 1D VDL from which the slowness pick was made. The error bars expand to include the asymptote just below the pick. The correct threshold parameters yield a slowness and time pick that is on top of that asymptote. The middle row shows the amplitude map (average instantaneous amplitude; left) and the signal-to-noise ratio map (right). The amplitude map and SNR map have identical structures. This is due to the fact that the SNR map is simply the log of a normalized version of the amplitude map. The bottom row shows the average instantaneous frequency map (left) and associated standard deviation (right). Both leaky P and the Stoneley wave are shown. The leaky P arrival has higher frequencies arriving first before the lower frequencies. This is not inverse dispersion, but rather simply due to the nature of the source signal with higher frequencies transmitted into the formation before lower frequencies. The Stoneley wave pick is associated with a frequency of about 0.5 kHz and a standard deviation of 0.1 kHz.

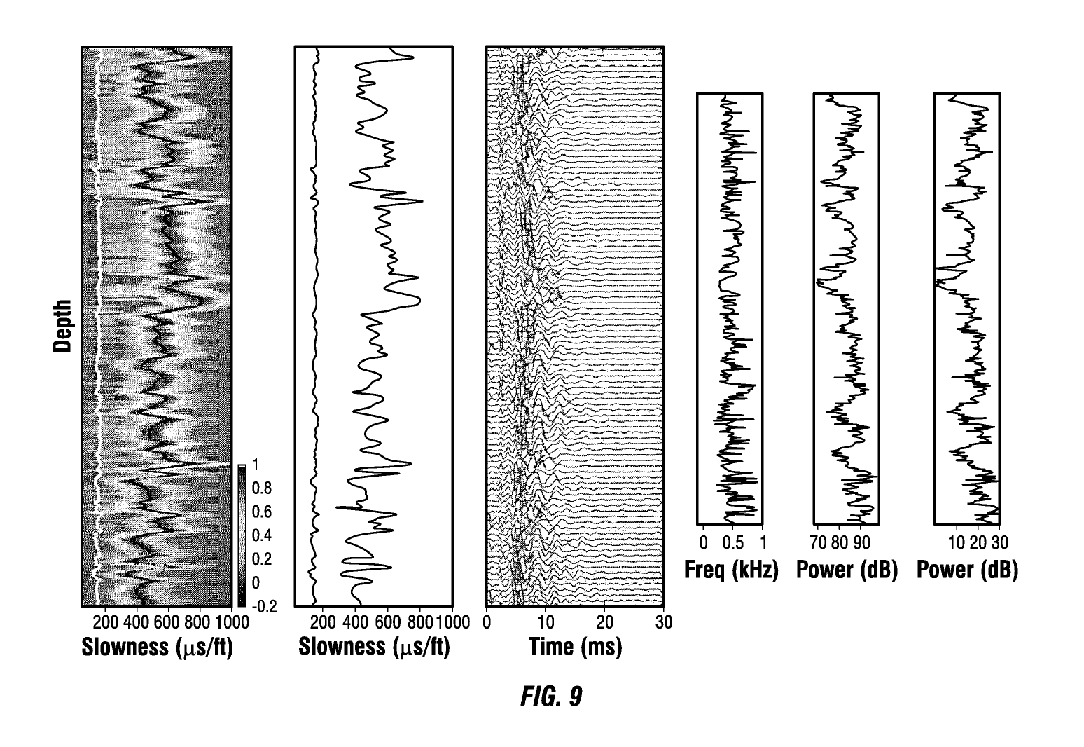

FIG. 9 shows measured first level 300 Stoneley slowness logs and associated QC displays for a soft formation spanning 500 ft. FIG. 9 illustrates from left to right: Stoneley 1D coherence VDL with picks shown as black dots; log of Stoneley (black), Stoneley using alternative method (red), slowness error bars (gray), and DTC (purple); filtered Stoneley waveforms with time picks; frequency log (with error bars), power log, and SNR log (0 dB means very weak signal). The compressional slowness (DTC) is approximately 150 μs/ft. The 1D VDL is shown as a 2D map on the far left, where the y axis is depth. The 2D map shows the ranges associated with low coherence (0) to high coherence (1). The black dots indicate first level 300 resulting slownesses.

The second log shows the same black dots, but also the slowness error bars in gray underneath. The purples curve is the compressional formation slowness (DTC) log. Also underneath may be a red curve outlining Stoneley slowness measurements using a traditional technique. The traditional technique has three fundamental issues. It will jump to incorrect arrivals when the Stoneley amplitudes are weak (in very soft formation or large boreholes). It may also be very sensitive to structure in the time series, which leads to random jitter in the slowness log. Lastly, there is no frequency associated with the slowness pick, which makes using that method difficult for rough petrophysical calculations.

The third log shows the filtered Stoneley waveforms. The red dots are the times associated with the slowness picks. There are many more red dots than there are waveforms and the waveforms are decimated for plotting purposes. The variation of the time picks track the variation of the slownesses. The first arriving energy on the waveforms is likely the leaky P arrival.

The final three logs on the right are frequency (with error bars), power (in dB), and signal-to-noise ratio (SNR, it is mislabeled Power). As expected, significant increases in Stoneley slowness correlate with significant reductions in frequency, power, and SNR.

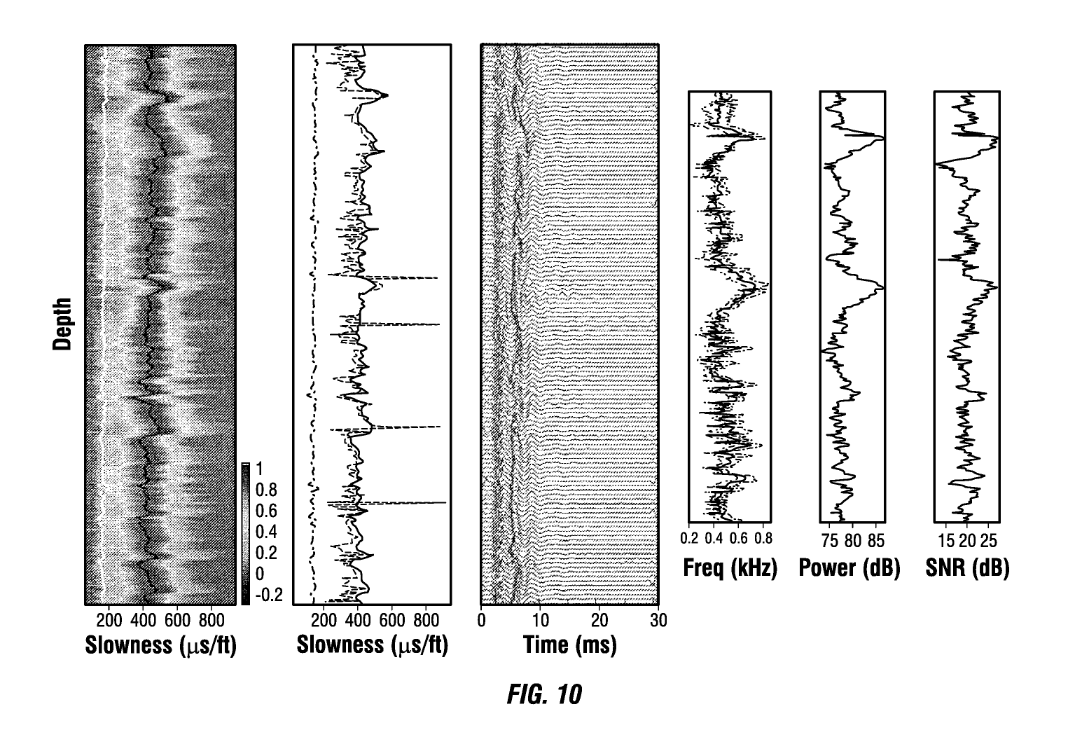

FIG. 10 shows another soft formation example spanning 400 feet where DTC=150 μs/ft. The example illustrates from left to right: Stoneley 1D coherence VDL with picks shown as black dots; log of Stoneley (black), Stoneley using alternative method (red), slowness error bars (gray), and DTC (purple); filtered Stoneley waveforms with time picks; frequency log (with error bars), power log, and SNR log (0 dB means very weak signal). This example shows locations where the coherence of the extensional tool mode is greater than the coherence of the Stoneley wave. At such depths, the traditional method picks an incorrect slowness between 300-350 μs/ft. This “noisy” picking happens where the dominant power level is below ˜77 dB (or ˜20 dB SNR). The proposed method picks the slowness reliably and smoothly through these weak-amplitude areas. Furthermore, the time picks correctly pick the highest energy part of the Stoneley wave arrival. Lastly, the logs of slowness, time picks, frequency, power, and SNR all correlate with each other.

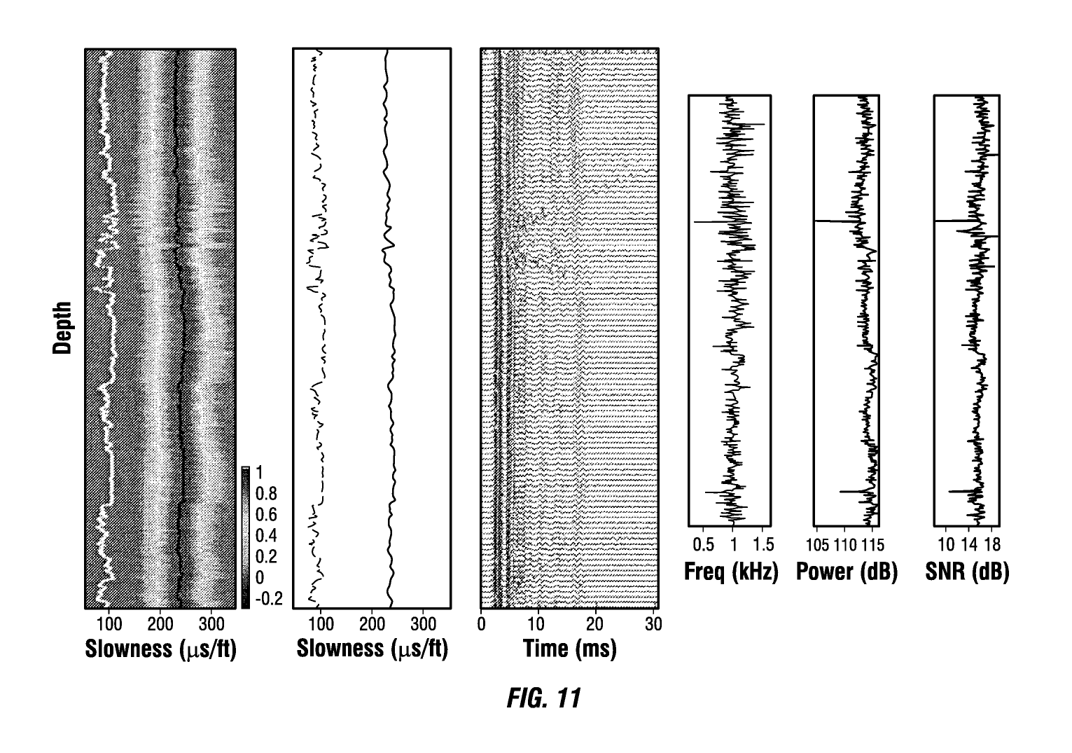

FIG. 11 presents a hard formation spanning 500 feet where DTC=80 us/ft. The figure illustrates from left to right: Stoneley 1D coherence VDL with picks shown as black dots; log of Stoneley (black), Stoneley using alternative method (red), slowness error bars (gray), and DTC (purple); filtered Stoneley waveforms with time picks; frequency log (with error bars), power log, and SNR log (0 dB means very weak signal). The picked slowness from the traditional method (red) overlays the new method (black) very well. However, the pick time from the old method is poorly constrained (not shown). By constraining the pick time, we are able to track frequency, power, and signal to noise ratio. The time pick can be seen to follow the first arriving, primary Stoneley wave. The subsequent arrivals in the waveforms that do not change their time with increasing depth are Stoneley reflections from items on the tool string. The chevron pattern seen 33% down from the top is a Stoneley reflection from an anomaly in the borehole such as a fracture or borehole washout. A weak half of a chevron pattern is also observed near the bottom of the well. The apices of both of these patterns are located about 20 feet from a sudden drop in frequency, power, and SNR. The frequencies in general are approximately 1 kHz, compared to approximately 0.5 kHz for both soft formation examples.

This method and system may include any of the various features of the compositions, methods, and system disclosed herein, including one or more of the following statements.

Statement 1: A method for measuring borehole Stoneley wave slowness comprising: disposing a downhole tool into a wellbore; broadcasting a waveform into a formation penetrated by the wellbore; recording the waveform from the formation with a receiver disposed on the downhole tool; separating the waveform into a plurality of waveforms to form a shot gather; conditioning the plurality of waveforms of the shot gather; identifying slowness constraints of the plurality of waveforms from a look up table; computing a time-slowness mask from the plurality of waveforms; computing a coherence map from the plurality of waveforms from a differential phase time semblance; creating a two-dimensional time-slowness map from the coherence map; determining slownesses from a one-dimensional variable density log from the two-dimensional time-slowness map; tracking time pick from the two-dimensional time-slowness map; identifying one or more of coherence, power, instantaneous frequency, signal-to-noise ratio, or error bars from the two-dimensional time-slowness map; and computing a spline interpolation locally from the two-dimensional time-slowness map around the pick from the one-dimensional variable density log to produce a final data product.

Statement 2: The method of statement 1, wherein recording the gathering waveforms further comprises computing a time delay between a start of a drive pulse and an onset of driving energy.

Statement 3: The method of statement 1 or statement 2, wherein the conditioning waveforms is determined from a table for sonic log processing.

Statement 4: The method of any preceding statement, wherein the computing a time-slowness mask comprises computing a window in time/slowness space.

Statement 5: The method of any preceding statement, wherein the computing a time-slowness mask comprises inputting at least one parameter comprising formation compressional slowness, mud density, or borehole diameter.

Statement 6: The method of any preceding statement, further comprising: applying waveform separation; computing frequency semblance; processing a two-dimensional frequency-slowness map; determining slownesses from a second one-dimensional variable density log; and picking a two-dimensional time-slowness map over a frequency range.

Statement 7: The method of any preceding statement, further comprising assuming realistic borehole parameters.

Statement 8: The method of any preceding statement, further comprising computing tool correction and a dispersion curve.

Statement 9: The method of any preceding statement, further comprising inverting the one-dimensional variable density log.

Statement 10: The method of any preceding statement, further comprising computing a tool correct Stoneley slowness value and a dispersion curve.

Statement 11: A well measurement system for measuring borehole Stoneley wave slowness comprising: a downhole tool, wherein the downhole tool comprises: a receiver; and a transmitter; a conveyance, wherein the conveyance is attached to the downhole tool; an information handling system wherein the information handling system is connected to the downhole tool and operable to broadcast a waveform with the transmitter into a formation, record the waveform from the formation with the receiver; separate the waveform into a plurality of waveforms to form a shot gather; condition the plurality of waveforms of the shot gather; identify slowness constraints of the plurality of waveforms from a look up table; compute a time-slowness mask from the plurality of waveforms; compute a coherence map from the plurality of waveforms from a differential phase time semblance; create a two-dimensional time-slowness map from the coherence map; determine slownesses from a one-dimensional variable density log from the two-dimensional time-slowness map; track time pick from the two-dimensional time-slowness map; identify one or more of coherence, power, instantaneous frequency, signal-to-noise ratio or error bars from the two-dimensional time-slowness map; and compute a final data product.

Statement 12: The well measurement system of statement 11, wherein the record the waveform further comprises compute a time delay between a start of a drive pulse and an onset of driving energy.

Statement 13: The well measurement system of statements 11 or statement 12, wherein the condition waveforms is determined from a table for sonic log processing.

Statement 14: The well measurement system of statements 11-13, wherein the compute a time-slowness mask comprises compute a window in time/slowness space.

Statement 15: The well measurement system of statements 11-14, wherein the compute a time-slowness mask comprises inputting at least one parameter comprising formation compressional slowness, mud density, or borehole diameter.

Statement 16: The well measurement system of statements 11-15, wherein the information handling system is further operable to: apply waveform separation; compute frequency semblance; process a two-dimensional frequency-slowness map; determine slownesses from a second one-dimensional variable density log; and pick a two-dimensional time-slowness map over a frequency range.

Statement 17: The well measurement system of statements 11-16, further comprising assuming realistic borehole parameters.

Statement 18: The well measurement system of statements 11-17, wherein the information handling system is further operable to compute tool correction and a dispersion curve.

Statement 19: The well measurement system of statements 11-18, wherein the information handling system is further operable to invert the one-dimensional variable density log.

Statement 20: The well measurement system of statements 11-19, wherein the information handling system is further operable to compute a tool correct Stoneley slowness value and a dispersion curve.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for measuring borehole Stoneley wave slowness comprising:
disposing a downhole tool into a wellbore;
broadcasting a waveform into a formation penetrated by the wellbore;
recording the waveform from the formation with a receiver disposed on the downhole tool;
separating the waveform into a plurality of waveforms to form a shot gather;
conditioning the plurality of waveforms of the shot gather;
identifying slowness constraints of the plurality of waveforms from a look up table;
computing a time-slowness mask from the plurality of waveforms;
computing a coherence map from the plurality of waveforms from a differential phase time semblance;
creating a two-dimensional time-slowness map from the coherence map;
determining slownesses from a one-dimensional variable density log from the two-dimensional time-slowness map;
tracking time pick from the two-dimensional time-slowness map;
identifying one or more of coherence, power, instantaneous frequency, signal-to-noise ratio, or error bars from the two-dimensional time-slowness map; and
computing a spline interpolation locally from the two-dimensional time-slowness map around the pick from the one-dimensional variable density log to produce a final data product.

2. The method of claim 1, wherein the recording the waveform further comprises computing a time delay between a start of a drive pulse and an onset of driving energy.

3. The method of claim 1, wherein the conditioning waveforms is determined from a table for sonic log processing.

4. The method of claim 1, wherein the computing a time-slowness mask comprises computing a window in time/slowness space.

5. The method of claim 1, wherein the computing a time-slowness mask comprises inputting at least one parameter comprising formation compressional slowness, mud density, or borehole diameter.

6. The method of claim 1, further comprising:
applying waveform separation;
computing frequency semblance;
processing a two-dimensional frequency-slowness map;
determining slownesses from a second one-dimensional variable density log; and
picking a two-dimensional time-slowness map over a frequency range.

7. The method of claim 6, further comprising assuming realistic borehole parameters.

8. The method of claim 7, further comprising computing tool correction and a dispersion curve.

9. The method of claim 6, further comprising inverting the one-dimensional variable density log.

10. The method of claim 9, further comprising computing a tool correct Stoneley slowness value and a dispersion curve.

11. A well measurement system for measuring borehole Stoneley wave slowness comprising:
a downhole tool, wherein the downhole tool comprises:
a receiver; and
a transmitter;
a conveyance, wherein the conveyance is attached to the downhole tool;
an information handling system wherein the information handling system is connected to the downhole tool and operable to broadcast a waveform with the transmitter into a formation, record the waveform from the formation with the receiver; separate the waveform into a plurality of waveforms to form a shot gather; condition the plurality of waveforms of the shot gather; identify slowness constraints of the plurality of waveforms from a look up table; compute a time-slowness mask from the plurality of waveforms; compute a coherence map from the plurality of waveforms from a differential phase time semblance; create a two-dimensional time-slowness map from the coherence map; determine slownesses from a one-dimensional variable density log from the two-dimensional time-slowness map; track time pick from the two-dimensional time-slowness map; identify one or more of coherence, power, instantaneous frequency, signal-to-noise ratio or error bars from the two-dimensional time-slowness map; and compute a final data product.

12. The well measurement system of claim 11, wherein the record the waveform further comprises compute a time delay between a start of a drive pulse and an onset of driving energy.

13. The well measurement system of claim 11, wherein the condition waveforms is determined from a table for sonic log processing.

14. The well measurement system of claim 11, wherein the compute a time-slowness mask comprises compute a window in time/slowness space.

15. The well measurement system of claim 11, wherein the compute a time-slowness mask comprises inputting at least one parameter comprising formation compressional slowness, mud density, or borehole diameter.

16. The well measurement system of claim 11, wherein the information handling system is further operable to:
apply waveform separation;
compute frequency semblance;
process a two-dimensional frequency-slowness map;
determine slownesses from a second one-dimensional variable density log; and
pick a two-dimensional time-slowness map over a frequency range.

17. The well measurement system of claim 16, further comprising assuming realistic borehole parameters.

18. The well measurement system of claim 17, wherein the information handling system is further operable to compute tool correction and a dispersion curve.

19. The well measurement system of claim 16, wherein the information handling system is further operable to invert the one-dimensional variable density log.

20. The well measurement system of claim 16, wherein the information handling system is further operable to compute a tool correct Stoneley slowness value and a dispersion curve.
